(19) United States
(12) Patent Application Publication
(10) Pub. No.: US 2020/0107676 A1
(43) Pub. Date: Apr. 9, 2020

(54) RESISTIVE CHARCOAL IGNITER SYSTEM AND METHOD

(71) Applicant: Charles Gary Grantham, Hidden Valley Lake, CA (US)

(72) Inventor: Charles Gary Grantham, Hidden Valley Lake, CA (US)

(21) Appl. No.: 16/274,221

(22) Filed: Feb. 12, 2019

Related U.S. Application Data
(60) Provisional application No. 62/742,219, filed on Oct. 5, 2018.

(51) Int. Cl. A47J 37/07; F23Q 7/02

(52) U.S. Cl. CPC A47J 37/079; F23Q 7/02

(57) ABSTRACT

Disclosed is a resistive charcoal igniter device for containing and igniting charcoal briquettes, particularly in preparation for use in a barbeque. The device has a cylindrical container with a wire base or tray in the bottom for containing the briquettes. An electrically operated resistive heating element is located within the wire base. When briquettes are placed in the container and the heating element is energized, the charcoal briquettes can be ignited after a sufficient time. The device also includes a handle affixed to the container and a heat shield placed between the handle and the container to protect a user's hand from heat generated within the container while holding the handle. The resistive heater is powered externally and may be electrically connected to a power source by an extension cord integrated into the device.

### CROSS-REFERENCE TO RELATED APPLICATION(S)

The present application is related to and claims priority to U.S. Provisional Patent Application No. 62/742,219 filed Oct. 5, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of barbeque cooking of existing art and more specifically relates to fuel lighters.

### RELATED ART

Cooking using a charcoal fired barbecue is an effective and satisfying means of preparing a meal. Proponents of barbecue cooking often prefer the health advantages, taste preferences, or involved technique provided by cooking with a barbecue. However, many people avoid charcoal fired barbecue cooking simply because they find it difficult, messy, or inconvenient. In particular, lighting the charcoal can present a dreaded chore for many. Charcoal briquettes can be difficult to light using simply a match or other light flame sources, and it can also be messy trying to light the briquettes in the basin underneath the barbecue grill. Flammable fluids may make lighting easier but can be hazardous and produce an unpleasant taste in the food prepared using those briquettes. The storage and safe use of flammables presents potential fire danger. These consumable materials must be repurchased adding to event expense. This difficulty in lighting charcoal briquettes may be one of the primary reasons that propane and electric cooking methods are often chosen over barbecue cooking. A suitable solution is desired.

U.S. Pat. No. 5,197,455 to Ross Tessien relates to a charcoal starter. The described charcoal starter includes an improved charcoal starter that employs a grate having a conical shaped charcoal briquette receiving and stacking portion, to permit an enhanced rise of heat to impact the coals to get them to burn. The heat may come from paper kindling as conventionally disposed beneath the grate, or from a resistance heater element built into the grate. The grate may resemble a witch's hat with the retaining disk being the brim and a conical portion being disposed thereon, both with suitable apertures therein; or the grate can be made of suitable wire. The grate may be permanently mounted within the starter's cylindrical body or be removable therefrom.

### SUMMARY OF THE INVENTION

In view of the foregoing disadvantages inherent in the known fuel lighter art, the present disclosure provides a novel resistive charcoal igniter system and method which is friendlier to the environment. The general purpose of the present disclosure, which will be described subsequently in greater detail, is to provide a resistive charcoal igniter system and method.

Disclosed is a resistive charcoal igniter device for containing and igniting charcoal briquettes, particularly in preparation for use in a barbeque. The device has a cylindrical container with a wire base or tray in the bottom for containing the briquettes. An electrically operated resistive heating element is located within the wire base. When briquettes are placed in the container and the heating element is energized, the charcoal briquettes can be ignited after a sufficient time. The device also includes a handle affixed to the container and a heat shield placed between the handle and the container to protect a user's hand from heat generated within the container while holding the handle. The resistive heater is powered externally and may be electrically connected to a power source by an extension cord integrated into the device.

According to another embodiment, a method of igniting charcoal briquettes is also disclosed herein. The method of igniting charcoal briquettes includes providing the above-described device, inserting one or more briquettes into the cylinder through the top-end, depositing briquettes onto the tray, plugging the cord into a power source such as a wall outlet, heating the resistive heating element, igniting the briquettes by means of their proximity to the resistive heating element, and dispensing the briquettes into a cooking device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a resistive charcoal igniter system and method, constructed and operative according to the teachings of the present disclosure.

FIG. 1 is a perspective view of the device according to an embodiment of the disclosure.

FIG. 2 is a rear perspective view of the device of FIG. 1, according to an embodiment of the present disclosure.

FIG. 3 is a side perspective view of the device of FIG. 1, according to an embodiment of the present disclosure.

FIG. 4 is a top perspective view of the device of FIG. 1, according to an embodiment of the present disclosure.

FIG. 5 is a flow diagram illustrating a method of use for containing and igniting charcoal briquettes, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fuel lighter and more particularly to a resistive charcoal igniter system and method as used to improve the lighting of charcoal briquettes for a barbecue.

The resistive charcoal igniter system includes a device for containing and igniting charcoal briquettes, particularly in preparation for use in a barbeque. The device includes a cylindrical container with a wire base in the bottom for containing the briquettes. The cylinder may be constructed of galvanized sheet steel and have apertures providing ventilation and airflow.

An electrically operated resistive heating element is located within the wire base. When briquettes are placed in the container and the heating element is energized, the charcoal briquettes can be ignited after sufficient time. The device also includes a handle affixed to the container and a heat shield placed between the handle and the container to protect a user's hand from heat generated within the container while holding the handle.

The resistive heater is powered externally and may be electrically connected to a power source by an extension cord integrated into the device. A power button may be included for switching the resistive heater on and off when the device is connected to a power source. No fan or forced circulation means is necessary; rather, the device utilized concentrated heat and passive ventilation to ignite the briquettes. Advantageously, the device incorporates a power supply providing options between four and six hundred watts to the resistive heating element, thereby encouraging reliable ignition.

In use, a user may simply connect the device to a voltage source, place briquettes within the cylinder, activate the heating element, and wait for the briquettes to ignite. Thus, the device does not need to be constantly monitored to verify ignition success. The briquette may be subsequently used for cooking in a barbecue if desired.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art. The resistive charcoal igniter system may include a cylinder, a handle, a heat shield, an articulated auxiliary handle, a tray, a resistive heating element, a power cord, and ventilation apertures.

The cylinder may be a thin hollow shell, preferably constructed of sheet metal. The handle may be coupled to the cylinder, providing a safe and rigid means of holding, lifting, and manipulating the cylinder. The ventilation apertures may be of sufficient size to greatly increase airflow through the cylinder and to encourage combustion within the cylinder. The articulated auxiliary handle may be a metal rod which is bent in a U-shape. The articulated auxiliary handle may be attached to the heat shield using two hooks which are integral to the articulated auxiliary handle and pass through apertures in the heat shield. The hooks may rotate within the apertures, thereby enabling the articulated auxiliary handle to move.

The power cord may act to electrically couple the resistive heating element to a voltage source. Preferably, the power cord includes a 120-volt type power plug, such as a NEMA-1 or a NEMA-5 plug able to connect to a household wall outlet. Accordingly, the power cord may include internal conduits comprising power, neutral, and ground. The power cord may further include a voltage regulator, a power switch, a transformer, or any combination thereof in various embodiments. The power cord may pass directing through an interior of the handle.

The handle itself may be constructed of plastic, metal, or a combination thereof. Preferably, the handle includes a sheet metal core having a first strut and a second strut, which each are rigidly coupled to the cylinder. A plastic handle may either couple the first strut and the second strut, or simply circumscribe the sheet metal core if the first strut and the second strut are integral to each other. The plastic handle may be sufficiently insulating to allow a user to comfortably grasp the handle even when combustion has been occurring within the cylinder for some time. The first and second struts may couple to the cylinder via screws, rivets, or other means. The first and second struts may take the shape of straight, flat bands with angled end pieces connecting to the cylinder.

The tray may be disposed within the bottom of the cylinder. In a preferred embodiment, the tray is composed of one or more metal rods which are bent to form a permeable support. However, the spaces within the tray are not large enough to allow briquettes to pass through the tray. In this way, the tray may reliably support one or more briquettes, while also enabling ample airflow to pass through the tray to encourage combustion within the cylinder. Because the tray in disposed within one end of the cylinder, the other end of the cylinder remains open, such that a user may deposit briquettes within the cylinder via the open end opposite the tray.

The resistive heating element may be mounted to or be integral to the tray. In a preferred embodiment, the tray includes three separate extension mounted at one end to the cylinder and disposed proximally to the resistive heating element which are structured to regulate the proximity of the briquettes to the resistive heating element. These three extensions may be affixed to two concentric rings which provide strength and rigidity to the tray. The resistive heating element may produce heat when energized by a voltage source. The heat may be sufficient to ignite a charcoal briquette in contact with or in proximity to the resistive heating element. Preferably, the resistive heating element has an output of approximately four to six hundred watts.

The heat shield may be disposed between the handle and the cylinder, and may be rigidly mounted to the handle, the cylinder, or both. The heat shield is preferably constructed of a material having a low emissivity, such as sheet steel or aluminum. The heat shield may help shield a user's hand from heat generated within the cylinder when the user is grasping the handle. The heat shield may be contoured around the cylinder to more effectively isolate heat away from the handle. Preferably, the cylinder is perforated, the perforations being the afore-mentioned ventilation apertures. The exact specifications, materials used, and method of use of the resistive charcoal igniter system may vary upon manufacturing.

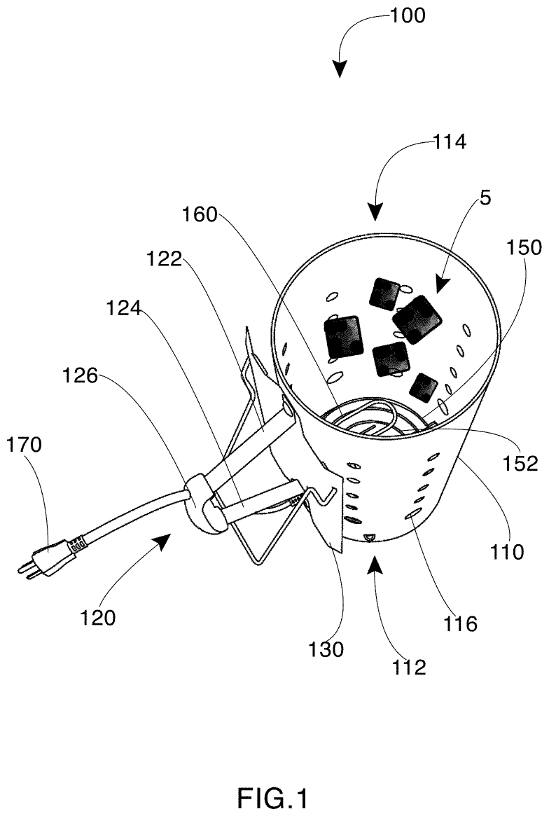

Referring now more specifically to the drawings by numerals of reference, there is shown in FIGS. 1-4, various views of a device 100.

FIG. 1 shows a device according to an embodiment of the present disclosure. The device 100 may be useful for containing and igniting charcoal briquettes. The device may include cylinder 110, handle 120, heat shield 130, articulated auxiliary handle 140, tray 150, resistive heating element 160, and power cord 170. Cylinder 110 may have bottom-end 112 and top-end 114. Bottom-end 112 and top-end 114 are opposite each other and represent circular apertures in either end of cylinder 110. Interior of cylinder 110 is substantially hollow. Tray 150 and resistive heating element 160 are contained inside cylinder 110. Handle 120 may be rigidly coupled to cylinder 110. Handle 120 may have first-strut 122 affixed to cylinder 110 proximally to top-end 114, and second-strut 124 affixed to cylinder 110 proximally to the second-end, and handle-grip 126 bridging first-strut 122 to second-strut 124. In some embodiments, handle-grip 126 may be plastic, with first-strut 122 and second-strut 124 being molded into handle-grip 126. Alternatively, first-strut 122 may be affixed to or even integral with second-strut 124, and handle-grip 126 may be molded about first-strut 122 and second-strut 124. Yet further, handle-grip 126 may be constructed of alternate materials or affixed to first-strut 122 and second-strut 124 may other means. Heat shield 130 may be rigidly coupled to handle 120. Preferably, heat shield and handle 120 are fastened to cylinder 110 by fasteners which pass through apertures in cylinder 110, handle 120, and heat shield 130. Articulated auxiliary handle 140 may be pivotably attached to heat shield 130 and may be configured to be selectively positioned beneath handle 120, such that the combination of articulated auxiliary handle 140 and bottom-end 112 of cylinder 110 are able to stably support device 100 on a surface. Tray 150 may be disposed interior to cylinder 110 and proximally to bottom-end 112. Tray 150 may have plurality of wire members 152 spaced sufficiently tightly to prevent charcoal briquette 5 from passing out through bottom-end 112 of cylinder 110. Tray 150 may be circular and may be concentric to cylinder 110. Resistive heating element 160 may be mounted interior to cylinder 110 and may be sufficiently proximal to tray 150 to heat and ignite charcoal briquette 5 when charcoal briquette 5 is resting upon tray 150. Power cord 170 able to selectively apply an electric current to resistive heating element 160. “Selectively” may mean when a control system such as a switch activates resistive heating element 160. Alternatively, “selectively” may merely mean when power cord 170 is plugged into a power source.

In some embodiments, cylinder 110 comprises galvanized sheet steel. Other highly reflective and radiant materials, such as aluminum or stainless steel, may be used alternatively. Heat shield 130 may be sandwiched between handle 120 and cylinder 110. Heat shield 130 may be constructed of a highly reflective metal. A highly reflective material may include metals having an emissivity ratio under 0.2. Device 100 may also include a plurality of circular ventilation-apertures 116 perforating cylinder 110. Plurality of circular ventilation-apertures 116 may provide sufficient passive airflow in cylinder 110 to enable combustion of charcoal briquette 5 within cylinder 110. Preferably, power cord 170 passes directly through an interior of handle 120, as illustrated.

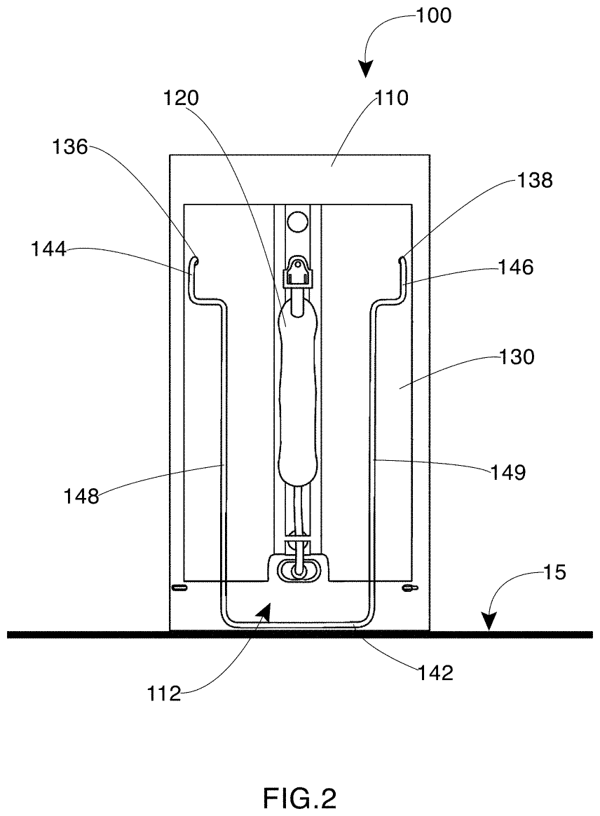

FIG. 2 shows device 100 of FIG. 1, according to an embodiment of the present disclosure. As shown, articulated auxiliary handle 140 may include straight base-strut 142, first-hook 144, second-hook 146 first-leg 148, and second-leg 149. Straight base-strut 142 may be configured to provide a secondary gripping location when articulated auxiliary handle 140 is deployed. First-hook 144 may pivotably engage heat shield 130, and second-hook 146 may likewise pivotably engage heat shield 130. First-leg 148 and second-leg 149 may each be perpendicularly arranged with straight base-strut 142, forming a squared U-shape. Each of first-hook 144 and second-hook 146 may also be formed into a square U-shape as illustrated. This may be advantageous to prevent accidental removal of articulated auxiliary handle 140 from heat shield 130. First-leg 148 may rigidly couple to first-hook 144 to straight base-strut 142, and second-leg 149 may likewise rigidly couple second-hook 146 to straight base-strut 142. This may be done with each element at such an orientation that first-hook 144 mirrors second-hook 146 across handle 120, and first-leg 148 mirrors second-leg 149 across handle 120.

Heat shield 130 may also include first-aperture 136 and second-aperture 138 perforating heat-shield 130. First-aperture 136 may be dimensioned and positioned to receive first-hook 144 of articulated auxiliary handle 140, and second-aperture 138 may likewise be dimensioned and positioned to receive second-hook 146 of articulated auxiliary handle 140. First-aperture 136 and second-aperture 138 may mirror each other over handle 120, with one being disposed on a left side of heat shield 130, and the other on the right.

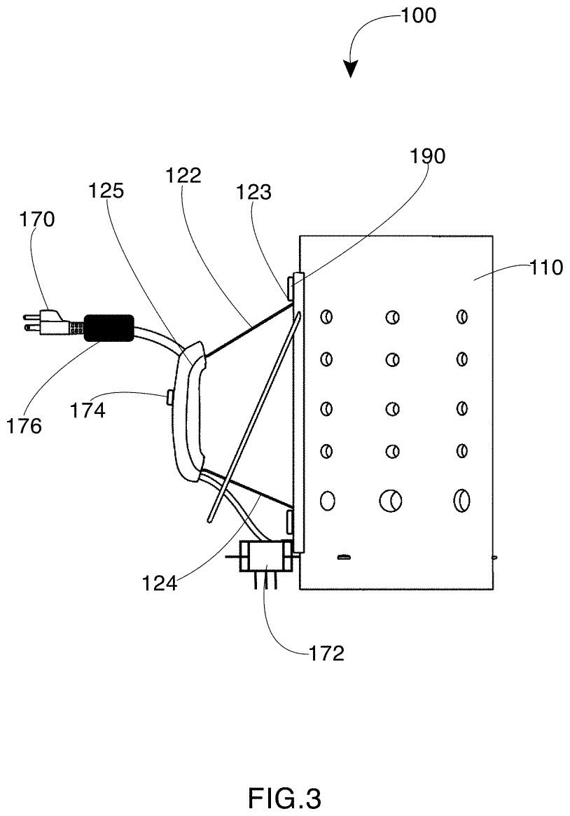

FIG. 3 may be a side perspective view of the device of FIG. 1, according to an embodiment of the present disclosure. First-strut 122 and second-strut 124 may each include, or be constructed of, a flat strip of metal, with each of the flat strips of metal having first-bend 123 and second-bend 125. Each of the first-bends 123 may be affixed to cylinder 110, and each of second-bends 125 may be affixed to handle-grip 126. Each of first-strut 122 and second-strut 124 may be fastened to cylinder 110 using fasteners 190, such that each of fasteners 190 pass through first-bend 123 of first-strut 122 and first-bend 123 of the second strut. The same fasteners 190 may also pass though cylinder 110. Fasteners 190 may be bolts, screws, rivets, or other fasteners.

Power cord 170 may include a 120-volt type power plug conforming to the NEMA-1 plug standard and alternatively the a NEMA-5 plug standard. This 120-volt type power plug may be able to removably couple to a household wall outlet and receive current thereby. In some embodiments, power cord 170 may also include voltage regulator 172 configured to limit the voltage applied to resistive heating element 160, power switch 174 able to selectively apply current to resistive heating element 160 only when engaged, and transformer 176 able to convert an alternating current signal to a direct current signal. Device 100 may also include a power supply adapter able to selectively provide four hundred watts to resistive heating element 160. Power supply adapter may be composed of one of the following, or a combination thereof: power cord 170, voltage regulator 172, power switch 174, and transformer 176. Various electric and electronic combinations or additions may be implemented. A system imparting four hundred watts to resistive heating element 160 has been found to be an unexpectedly advantageous solution and is the preferred method. Various electric and electronic control or timer components may be added. Resistive heating element wattage up to six hundred watts may be used in various configurations. Some of these components may be omitted, however. For example, some embodiments do not require either voltage control or on/off switches.

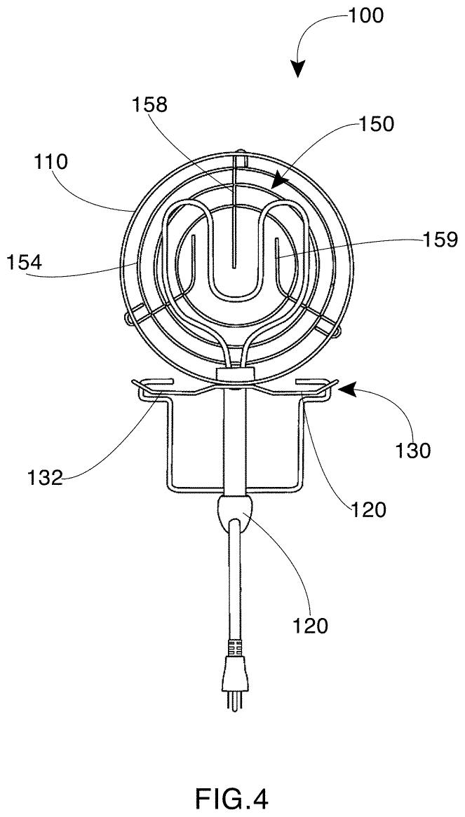

FIG. 4 may be a top perspective view of the device of FIG. 1, according to an embodiment of the present disclosure. Tray 150 may include at least two concentric wire rings 154 and at least one cross-member 156. At least one cross-member 156 may rigidly couple at least two concentric rings 154 to each other. At least one cross-member 156 may also rigidly couple at least two concentric rings 154 to cylinder 110. At least one cross-member may also include at least three extensions 158. Each of the three extensions 158 may rigidly couple at least two concentric rings 154 to cylinder 110, each of the three extensions 158 having bent terminus 159. Bent terminus 159 may be configured to distance charcoal briquette 5 (FIG. 1) from resistive heating element 160 when charcoal briquette 5 (FIG. 1) may be resting on tray 150. Bent terminus 159 may be angled by approximately forty-five degrees from each of the extensions 158 in some embodiments. Heat shield 130 may also include first-corrugation 132 and second-corrugation 134, wherein each of first-corrugation 132 and second-corrugation 134 protrude laterally from either side of handle 120, respectively, and wherein each of first-corrugation 132 and second-corrugation 134 are each concaved towards cylinder 110. Heat shield 130 may help prevent heat produced within cylinder 110 from burning a user's handle when holding handle 120. Preferably, first-corrugation 132 mirrors second-corrugation 134 across handle 120.

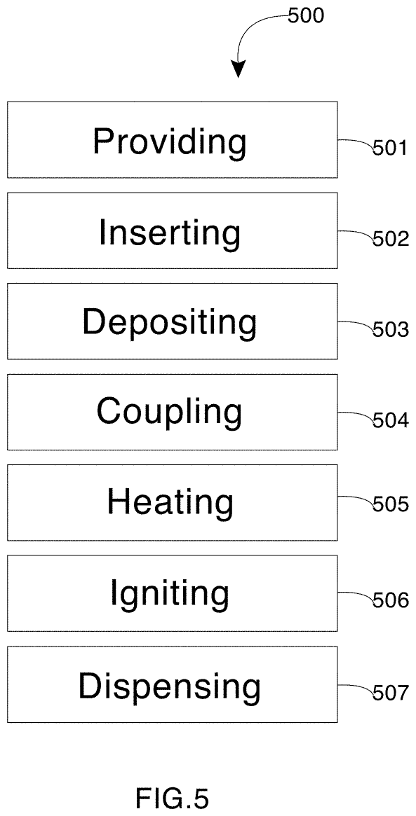

FIG. 5 is a flow diagram illustrating a method for lighting charcoal briquettes for a barbecue, according to an embodiment of the present disclosure. In particular, the method for light charcoal briquettes for a barbecue 500 may include one or more components or features of the device 100 as described above. As illustrated, the method for light charcoal briquettes for a barbecue 500 may include the steps of: step one 501, providing a device for containing and igniting charcoal briquettes, the device comprising a cylinder having a bottom-end and a top-end, a handle rigidly coupled to the cylinder, the handle having a first-strut affixed to the cylinder proximally to the top-end, and a second-strut affixed to the cylinder proximally to the second-end, and a handle-grip bridging the first-strut to the second-strut, a heat shield rigidly coupled to the handle, a tray disposed interior to the cylinder proximally to the bottom-end, the tray having a plurality of wire members spaced sufficiently tightly to prevent a charcoal briquette from passing out through the bottom-end of the cylinder, a resistive heating element mounted interior to the cylinder, the resistive heating element being sufficiently proximal to the tray to heat and ignite the charcoal briquette when the charcoal briquette is resting upon the tray, and a power cord able to selectively apply an electric current to the resistive heating element; step two 502, inserting at least one of the charcoal briquette into the cylinder through the top-end; step three 503, depositing the at least one of the charcoal briquette onto the tray; step four 504, coupling the power cord to a power source; step five 505, heating the resistive heating element; step six 506, igniting the at least one of the charcoal briquette in proximity to the resistive heating element; and step seven 507, dispensing the at least one of the charcoal briquette into a cooking device.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for light charcoal briquettes for a barbecue, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A device for containing and igniting charcoal briquettes, the device comprising:
a cylinder having a bottom-end and a top-end;
a handle rigidly coupled to the cylinder, the handle having a first-strut affixed to the cylinder proximally to the top-end, and a second-strut affixed to the cylinder proximally to the second-end, and a handle-grip bridging the first-strut to the second-strut;
a heat shield rigidly coupled to the handle;
a tray disposed interior to the cylinder proximally to the bottom-end, the tray having a plurality of wire members spaced sufficiently tightly to prevent a charcoal briquette from passing out through the bottom-end of the cylinder;
a resistive heating element mounted interior to the cylinder, the resistive heating element being sufficiently proximal to the tray to heat and ignite the charcoal briquette when the charcoal briquette is resting upon the tray;
and
a power cord able to selectively apply an electric current to the resistive heating element.

2. The device of claim 1, wherein the first-strut and the second-strut each comprise a flat strip of metal, each of the flat strips of metal having a first-bend and a second-bend, each of the first-bends being affixed to the cylinder, and each of the second-bends being affixed to the handle-grip.

3. The device of claim 1, wherein the tray comprises at least two concentric wire rings and at least one cross-member rigidly coupling the at least two concentric rings to each other.

4. The device of claim 3, wherein the at least one cross-member comprises at least three extensions, each of the three extensions rigidly coupling the at least two concentric rings to the cylinder, each of the three extensions having a bent terminus configured to distance the charcoal briquette from the resistive heating element when the charcoal briquette is resting on the tray.

5. The device of claim 1, wherein the cylinder comprises galvanized sheet steel.

6. The device of claim 1, wherein the heat shield is sandwiched between the handle and the cylinder.

7. The device of claim 1, wherein the heat shield further comprises a first-corrugation and a second-corrugation, wherein each of the first-corrugation and the second-corrugation protrude laterally from either side of the handle, respectively, and wherein each of the first-corrugation and the second-corrugation are each concaved towards the cylinder.

8. The device of claim 7, wherein the first-corrugation mirrors the second-corrugation across the handle.

9. The device of claim 1, further comprising a plurality of circular ventilation-apertures perforating the cylinder.

10. The device of claim 2, wherein the each of the first-strut and the second-strut are fastened to the cylinder using fasteners passing through the first-bend of the first-strut and the first-bend of the second-strut, the fasteners also passing though the cylinder, the fasteners being selected from the group consisting of bolts, screws, and rivets.

11. The device of claim 1, wherein the power cord further comprises a 120-volt type power plug conforming to the NEMA-1 plug standard and alternatively the NEMA-5 plug standard, the 120-volt type power plug being able to removably couple to a household wall outlet and receive current from the household wall outlet.

12. The device of claim 1, wherein the power cord further comprises a voltage regulator configured to limit the voltage applied to the resistive heating element, a power switch able to selectively apply current to the resistive heating element only when engaged, and a transformer.

13. The device of claim 1, wherein the power cord passes directly through an interior of the handle.

14. The device of claim 1, further comprising a power supply adapter able to selectively provide four hundred watts to the resistive heating element.

15. The device of claim 1, further comprising an articulated auxiliary handle pivotably attached to the heat shield, the articulated auxiliary handle being configured to provide a second grip location for a user, such that two hands may be used to grip and tilt the cylinder.

16. The device of claim 15, wherein the articulated auxiliary handle includes
a straight base-strut configured to provide a secondary gripping location when the articulated auxiliary handle is deployed;
a first-hook pivotably engaging the heat shield;
a second-hook pivotably engaging the heat shield;
a first-leg rigidly coupling the first-hook to the straight base-strut;
a second-leg rigidly coupling the second-hook to the straight base-strut;
such that the first-hook mirrors the second-hook across the handle; and
such that the first-leg mirrors the second-leg across the handle.

17. The device of claim 16, wherein the heat shield further comprises
a first-aperture dimensioned and positioned to receive the first-hook of the articulated auxiliary handle; and
a second-aperture dimensioned and positioned to receive the second-hook of the articulated auxiliary handle.

18. A resistance-heating charcoal igniter for containing and igniting charcoal briquettes, the resistance-heating charcoal igniter comprising:
a cylinder having a bottom-end and a top-end;
a handle rigidly coupled to the cylinder, the handle having a first-strut affixed to the cylinder proximally to the top-end, and a second-strut affixed to the cylinder proximally to the second-end, and a handle-grip bridging the first-strut to the second-strut;
a heat shield rigidly coupled to the handle;
a tray disposed interior to the cylinder proximally to the bottom-end, the tray having a plurality of wire members spaced sufficiently tightly to prevent a charcoal briquette from passing out through the bottom-end of the cylinder;
a resistive heating element mounted interior to the cylinder, the resistive heating element being sufficiently proximal to the tray to heat and ignite the charcoal briquette when the charcoal briquette is resting upon the tray; and
a power cord able to selectively apply an electric current to the resistive heating element;
wherein the first-strut and the second-strut each comprise a flat strip of metal, each of the flat strips of metal having a first-bend and a second-bend, each of the first-bends being affixed to the cylinder, and each of the second-bends being affixed to the handle-grip;
wherein the tray comprises at least two concentric wire rings and at least one cross-member rigidly coupling the at least two concentric rings to each other;
wherein the at least one cross-member comprises at least three extensions, each of the three extensions rigidly coupling the at least two concentric rings to the cylinder, each of the three extensions having a bent terminus configured to distance the charcoal briquette from the resistive heating element when the charcoal briquette is resting on the tray;
wherein the heat shield is sandwiched between the handle and the cylinder;
wherein the heat shield further comprises a first-corrugation and a second-corrugation, wherein each of the first-corrugation and the second-corrugation protrude laterally from either side of the handle, respectively, and wherein each of the first-corrugation and the second-corrugation are each concave toward the cylinder;
wherein the first-corrugation mirrors the second-corrugation across the handle;
further comprising a plurality of circular ventilation-apertures perforating the cylinder;
wherein the each of the first-strut and the second-strut are fastened to the cylinder using fasteners passing through the first-bend of the first-strut and the first-bend of the second strut, the fasteners also passing though the cylinder, the fasteners being selected from the group consisting of bolts, screws, and rivets;
wherein the power cord further comprises a 120-volt type power plug conforming to the NEMA-1 plug standard and alternatively the NEMA-5 plug standard, the 120-volt type power plug being able to removably couple to a household wall outlet and receive current from the household wall outlet;
wherein the power cord passes directly through an interior of the handle; and
wherein the power cord is able to provide between four and six hundred watts to the resistive heating element, and the heating element is able to operate up to at least six hundred watts.

19. A method of containing and igniting charcoal briquettes, the method comprising the steps of:
providing a device for containing and igniting charcoal briquettes, the device comprising a cylinder having a bottom-end and a top-end, a handle rigidly coupled to the cylinder, the handle having a first-strut affixed to the cylinder proximally to the top-end, and a second-strut affixed to the cylinder proximally to the second-end, and a handle-grip bridging the first-strut to the second-strut, a heat shield rigidly coupled to the handle, an articulated auxiliary handle pivotably attached to the heat shield, the articulated auxiliary handle being configured to provide a second grip location for a user, such that two hands may be used to grip and tilt the cylinder, a tray disposed interior to the cylinder proximally to the bottom-end, the tray having a plurality of wire members spaced sufficiently tightly to prevent a charcoal briquette from passing out through the bottom-end of the cylinder, a resistive heating element mounted interior to the cylinder, the resistive heating element being sufficiently proximal to the tray to heat and ignite the charcoal briquette when the charcoal briquette is resting upon the tray, and a power cord able to selectively apply an electric current to the resistive heating element;
inserting at least one of the charcoal briquettes into the cylinder through the top-end;
depositing the at least one of the charcoal briquettes onto the tray;
coupling the power cord to a power source;
heating the resistive heating element;
igniting the at least one of the charcoal briquettes in proximity to the resistive heating element; and
dispensing the at least one of the charcoal briquettes into a cooking device.
